(19) United States
(12) Patent Application Publication
(10) Pub. No.: US 2006/0291235 A1
(43) Pub. Date: Dec. 28, 2006

(54) LIGHT TUBE SYSTEM

(75) Inventor: Westerveld Johannes Hendrikus, Sedona, AZ (US)

Correspondence Address: NIKOLAI & MERSEREAU, P.A., 900 SECOND AVENUE SOUTH, SUITE 820, MINNEAPOLIS, MN, 55402, US

(73) Assignee: OMNILUX LIGHTING, LLC., Sedona, AZ (US)

(21) Appl. No.: 11/307,238

(22) Filed: Jan. 27, 2006

(30) Foreign Application Priority Data
Jun. 14, 2005 (TW) 94209951

(51) Int. Cl. G02B 6/00

(52) U.S. Cl. 362/551

(57) ABSTRACT

A light tube holder includes two internal sockets, an external socket and a plug. The internal sockets of the light tube holder can receive two pair of pins of a light tube. The external socket of the light tube holder can receive the plug of another light tube holder so that the light tube holders are connected to each other.

### BACKGROUND OF INVENTION

1. Field of Invention

The present invention relates to a light tube system and, more particularly, to an assembly of a holder with a connector.

2. Related Prior Art

Disclosed in Taiwanese Patent Publication No. 274354 is a light tube system of identical units. Each of the units includes a light tube 70, a transparent tube 10, two rings 60, two plugs 50, two caps 20 and two electric blocks 30 and 40. The rings 60 are located between the light tube 70 and the transparent tube 10. The plugs 50 are fit in the ends of the transparent tube 10. Thus, the light tube 70 is firmly located in the transparent tube 10. The electric blocks 30 and 40 are electrically connected to the light tube 70. The electric blocks 30 and 40 are located in the caps 20. The caps 20 receive the ends of the transparent tube 10. Each of the caps 20 consists of two halves. Each of the caps 20 includes a plurality of rods 22. The transparent tube 10 defines a plurality of apertures 11 for receiving the rods 22. Each of the caps 20 defines a plurality of apertures 23. Each of the apertures 23 can receive a plug 81 of a transformer 80 or a plug 91 of a connector 90.

There are problems with this conventional light tube system. Firstly, its configuration is complicated for including many complicated elements. Secondly, its cost is high. Thirdly, the interconnection of the units is not form. Fourthly, correct forming of each of the units is not ensured since the difference between the electric blocks 30 and 40 cannot be observed. Fifthly, correct interconnection of the units is not ensured because the difference between the electric blocks 30 and 40 cannot be observed.

The present invention is therefore intended to obviate or at least alleviate the problems encountered in prior art.

### SUMMARY OF INVENTION

According to the present invention, a light tube holder includes two internal sockets, an external socket and a plug. The internal sockets of the light tube holder can receive two pair of pins of a light tube. The external socket of the light tube holder can receive the plug of another light tube holder so that the light tube holders are connected to each other.

An advantage of the light tube holder of the present invention is its simple configuration.

Another advantage of the light tube holder of the present invention is its low cost.

Another advantage of the light tube holder of the present invention is that a light tube system can easily be made of a plurality of light tube holders.

Another advantage of the light tube holder of the present invention is its firm connection to the other light tube holder.

Another advantage of the light tube holder of the present invention is that the configuration of the socket is complementary to that of the plug so as to ensure its correct connection to the other light tube holder.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a perspective view of a light tube system including two light tube units and a connector according to the preferred embodiment of the present invention.

FIG. 2 is an exploded view of the light tube system shown in FIG. 1.

FIG. 3 is a perspective view of the light tube system in another position than shown in FIG. 1.

FIG. 4 is a cross-sectional view of the light tube system along a line 4-4 in FIG. 3.

FIG. 5 is a perspective view of the light tube system in another position than shown in FIG. 3.

FIG. 6 is a perspective view of a light tube system including five light tube units and four connectors as shown in FIG. 1.

FIG. 7 is an exploded view of a light tube system including two light tube units as shown in FIG. 1.

FIG. 8 is a perspective view of the light tube system shown in FIG. 7.

### DETAILED DESCRIPTION OF PREFERRED EMBODIMENT

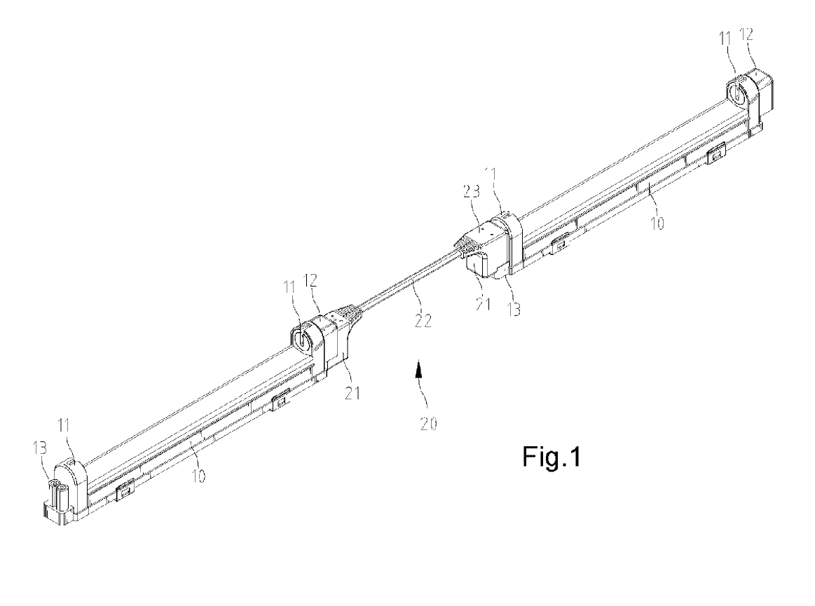

Referring to FIGS. 1 through 5, there is shown a light tube system including two light tube units and a connector 20 for interconnecting the light tube units according to the preferred embodiment of the present invention. Each of the light tube units includes a typical light tube that is omitted for the clarity of the drawings and a holder 10 for holding the light tube.

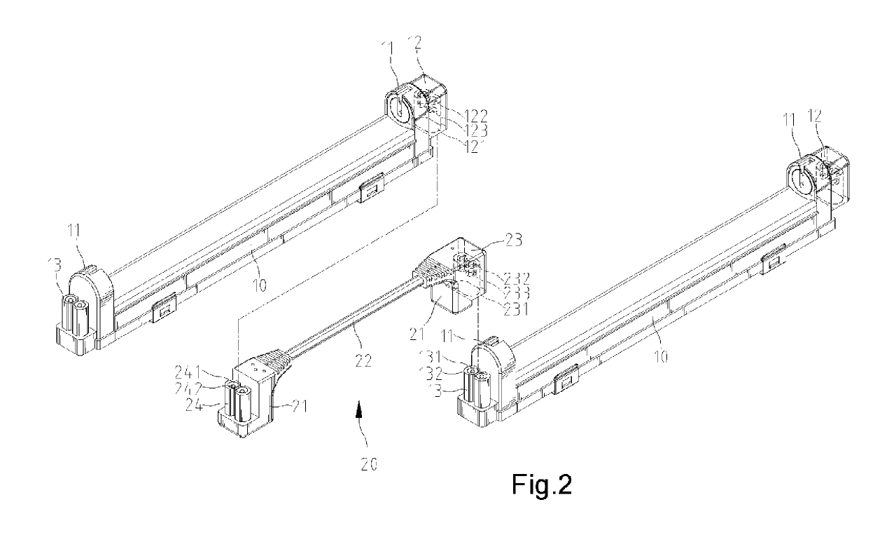

Referring to FIG. 2, each of the holders 10 includes two sockets 111 at two ends for receiving two pairs of pins of such a typical light tube, a socket 12 at one of the ends and a plug 13 at the other end.

The socket 12 includes a cap 121, two cylinders 122 protruding from the ceiling of the cap 121 and two receptacles 123 fit in the cylinders 122. The cap 121 and the cylinders 122 are electrically isolative while the receptacles 123 are electrically conductive.

The plug 13 includes two cylinders 131 and two pins 132 located in the cylinders 131. The cylinders 131 are electrically isolative while the pins 132 are electrically conductive.

The connector 20 includes a plug 21, a socket 23 and a cable 22 for connecting the socket 23 to the plug 21.

The plug 21 includes two cylinders 241 and two pins 242 located in the cylinders 241. The cylinders 241 are electrically isolative while the pins 242 are electrically conductive. The configuration and function of the plug 21 is like that of the plug 13.

The socket 23 includes a cap 231, two cylinders 232 protruding from the ceiling of the cap 231 and two receptacles 233 fit in the cylinders 232. The cap 231 and the cylinders 232 are electrically isolative while the receptacles 233 are electrically conductive. The configuration and function of the socket 23 is like that of the socket 12.

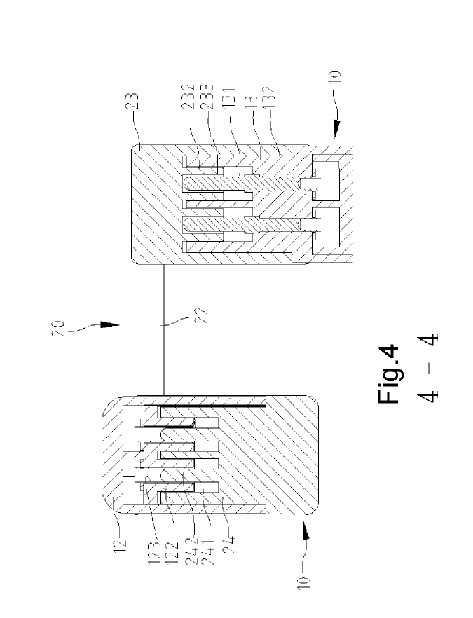

Referring to FIG. 4, the receptacles 123 of one of the holders 10 receive the pins 242, and the receptacles 233 receive the pins 132 of the other holder 10. Thus, the holders 10 are electrically connected to each other by means of the connector 20.

The cap 121 of one of the holders 10 receives the cylinders 241 while the cylinders 241 receive the cylinders 122 of the holder 10. The cap 23 receives the cylinders 131 of the other holder 10 while the cylinders 131 of the holder 10 receive the cylinders 232. Thus, the holders 10 are mechanically connected to each other by means of the connector 20.

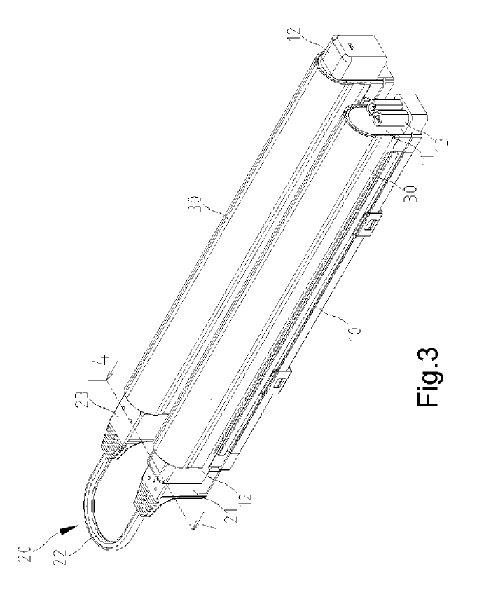

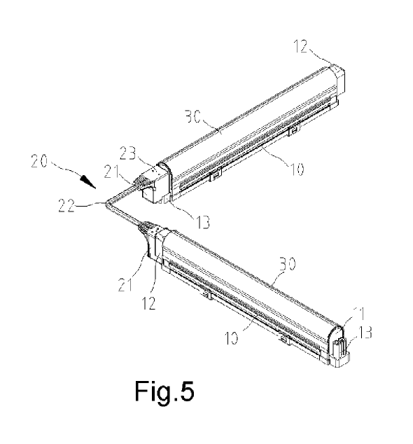

Referring to FIGS. 1, 3 and 5, the system can be located in various positions in various environments. Referring to FIGS. 3 and 5, such a typical light tube installed on each of the holders 10 is covered by means of transparent or translucent cover 30.

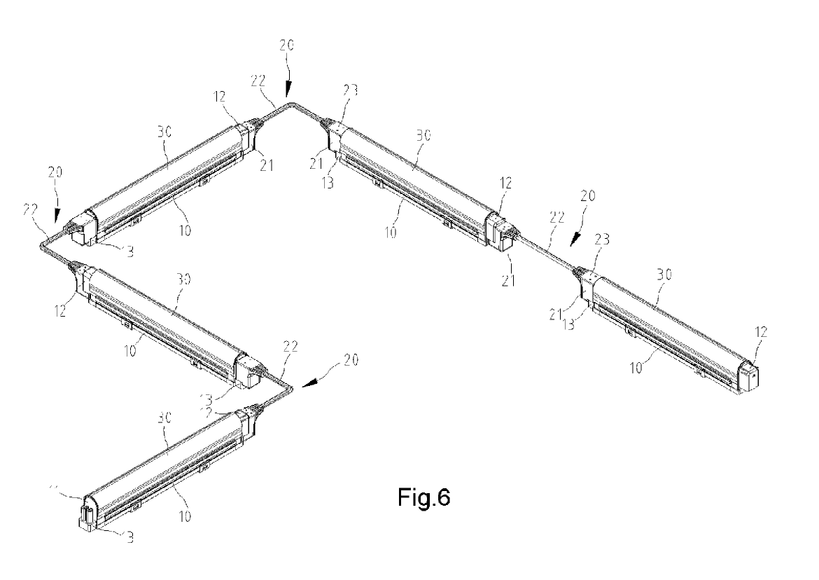

Referring to FIG. 6, there is shown a light tube system including five holders 10 and four connectors 20.

As described referring to FIGS. 1 through 6, according to the present invention, a light tube system includes a first number of light tube units and a second number of connectors. The second number is one less than the first number.

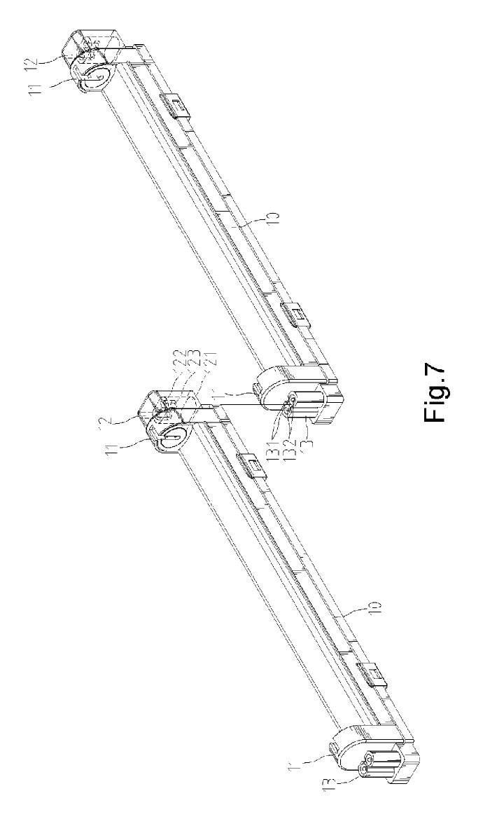

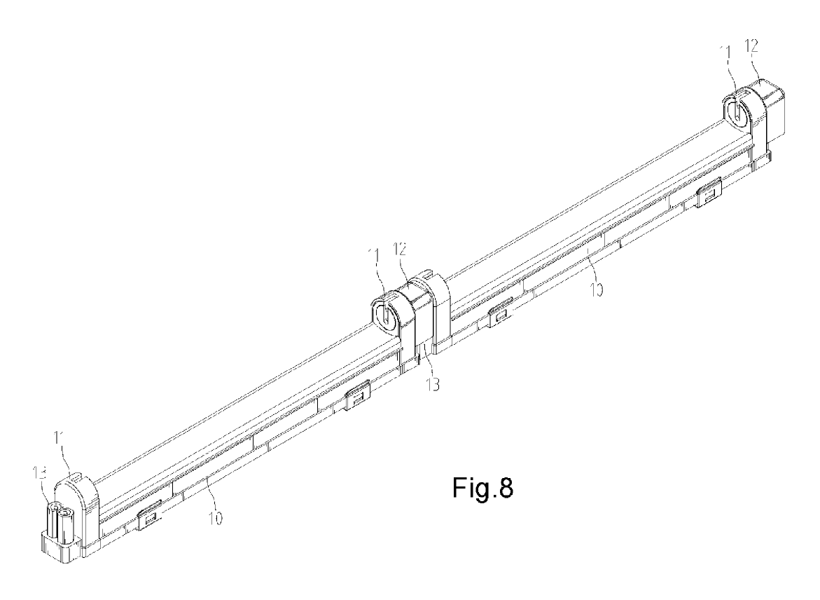

Referring to FIGS. 7 and 8, according to the present invention, a light tube system may include only the light tube units. The receptacles 123 of one of the holders 10 receive the pins 132 of the other holder 10 so that the holders 10 are electrically connected to each other. The cap 12 of one of the holders 10 receives the cylinders 131 of the other holder 10 while the cylinders 131 of the latter receive the cylinders 122 of the former so that the holders 10 are mechanically connected to each other.

The light tube system of the present invention exhibits a plurality of advantages. Firstly, its configuration is simple. Secondly, its cost is low. Thirdly, firm is the connection of the holders 10 to each other, with or without the use of the connectors 20. Fourthly, the configuration of the socket 12 is complementary to that of the plug 13 so as to ensure correct connection of the holders 10 to each other.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A light tube holder comprising two internal sockets for receiving two pair of pins of a light tube, an external socket and a plug for fitting in the external socket of another light tube holder.

2. The light tube holder according to claim 1 wherein the external socket comprises two receptacles, wherein the plug comprises two pins for fitting in the receptacles of another light tube holder.

3. The light tube holder according to claim 2 wherein the external socket comprises two cylinders around the receptacles, wherein the plug comprises two cylinders for receiving the cylinders of the external socket of another light tube holder.

4. The light tube holder according to claim 3 wherein the external socket comprises a cap for receiving the cylinders of the plug of another light tube holder.

5. A light tube unit comprising the light tube holder according to claim 1 and a cover installed on the light tube holder.

6. The light tube unit according to claim 5 wherein the cover is transparent.

7. The light tube unit according to claim 5 wherein the cover is translucent.

8. A light tube system including a first number of light tube units and a second number of connectors for connecting the first number of light tube units to one another, wherein the second number is one less than the first number.

9. The light tube system according to claim 8 wherein each of the light tube unit comprises a holder for receiving a light tube.

10. The light tube system according to claim 9 wherein the holder comprises an external socket and a plug, wherein each of the connectors comprises a plug for fitting in the external socket of one of the holders and a socket for receiving the plug of another holder.

11. The light tube system according to claim 10 wherein the external socket comprises two receptacles, wherein the plug of each of the connectors comprises two pins for fitting in the receptacles of the external socket.

12. The light tube holder according to claim 11 wherein the external socket comprises two cylinders around the receptacles, wherein the plug of each of the connectors comprises two cylinders for receiving the cylinders of the external socket.

13. The light tube holder according to claim 12 wherein the external socket comprises a cap for receiving the cylinders of the plug of related one of the connectors.

14. The light tube system according to claim 10 wherein the plug of each of the holders comprises two pins, wherein the socket of each of the connectors comprises two receptacles for receiving the pins of the plug of related one of the holders.

15. The light tube holder according to claim 14 wherein the socket of each of the connectors comprises two cylinders around the receptacles, wherein the plug of each of the holders comprises two cylinders for receiving the cylinders of the socket of related one of the connectors.

16. The light tube holder according to claim 15 wherein the socket of each of the connectors comprises a cap for receiving the cylinders of the plug of related one of the holders.

17. The light tube system according to claim 8 wherein each of the light tube units comprises a cover installed on the holder.

18. The light tube unit according to claim 17 wherein the cover is transparent.

19. The light tube unit according to claim 17 wherein the cover is translucent.
